(19) United States
(12) Patent Application Publication
(10) Pub. No.: US 2016/0084976 A1
(43) Pub. Date: Mar. 24, 2016

(54) PROCESSING OF MULTI-SENSOR STREAMER DATA

(71) Applicant: CGG SERVICES SA, Massy (FR)

(72) Inventor: Bruno GRATACOS, Saint-Remy-Les-Chevreuse (FR)

(21) Appl. No.: 14/888,759

(22) PCT Filed: May 28, 2014
(86) PCT No.: PCT/EP2014/061103

§ 371 Date: Nov. 3, 2015

Related U.S. Application Data
(60) Provisional application No. 61/828,409, filed on May 29, 2013.
(60) Provisional application No. 61/831,356, filed on Jun. 5, 2013.

(51) Int. Cl. G01V 1/36

(52) U.S. Cl. CPC G01V 1/362; G01V 1/364; G01V 2210/44; G01V 2210/56

(57) ABSTRACT

Presented are methods and systems for predicting a seismic data related quantity. The prediction is based on a linear least mean square estimate associated with covariance matrices. The application of a prediction error filter provides the ability to derive the prediction for aliased data samples.

### RELATED APPLICATION

The present application is related to, and claims priority from U.S. Provisional Patent Application No. 61/828,409, filed May 29, 2013, entitled “PROCESSING OF MULTI-SENSORS STREAMER DATA,” to Bruno GRATACOS, the disclosure of which is incorporated herein by reference and U.S. Provisional Patent Application No. 61/831,356, filed Jun. 5, 2013, similarly entitled “PROCESSING OF MULTI-SENSORS STREAMER DATA,” to Bruno GRATACOS, the disclosure of which is incorporated herein by reference.

### TECHNICAL FIELD

Embodiments of the subject matter disclosed herein generally relate to methods and systems for seismic data processing and, more particularly, to mechanisms and techniques for predicting a wave field quantity at a desired location and depth.

### BACKGROUND

Seismic data acquisition and processing techniques are used to generate a profile (image) of a geophysical structure (subsurface) of the strata underlying the land surface or seafloor. Among other things, seismic data acquisition involves the generation of acoustic waves and the collection of reflected/refracted versions of those acoustic waves to generate the image. This image does not necessarily provide an accurate location for petroleum and gas reservoirs, but it may suggest, to those trained in the field, the presence or absence of petroleum and/or gas reservoirs. Thus, providing an improved image of the subsurface in a shorter period of time is an ongoing process in the field of seismic surveying.

In order to provide some background, consider first a seismic data acquisition process and system as will now be described with respect to FIG. 1. In FIG. 1, a data acquisition system 100 includes a ship 102 towing a plurality of streamers 104 that can extend one or more kilometers behind the ship 102. Each of the streamers 104 can include one or more “birds” 106 that maintain the streamer 104 in a known fixed position relative to other streamers 104. Further, the one or more “birds” 106 are capable of moving the streamers 104 as desired according to bi-directional communications received by the birds 106 from the ship 102.

One or more source arrays 108 can also be towed by ship 102, or another ship (not shown), for generating seismic waves. Source arrays 108 can be placed either in front of or behind the receivers 112 (one representative receiver per streamer), or both behind and in front of the receivers 112. The seismic waves generated by the source arrays 108 propagate downward, reflect off of, and penetrate the seafloor, wherein the refracted waves eventually are reflected by one or more reflecting structures (not shown in FIG. 1) back to the surface of the sea. The reflected seismic waves then propagate upward and are detected by the receivers 112 disposed on the streamers 104. The seismic waves then reflect off of the free surface, i.e., the surface of the sea, traveling downward and are once again detected by the receivers 112 disposed on streamers 104 as receiver ghosts. This process is generally referred to as “shooting” a particular seafloor area, with the seafloor area referred to as a “cell” and the sea surface referred to as a “free surface.”

Thus, the arrival of a primary marine seismic wave at the receivers 112 is accompanied by a ghost reflection. In other words, ghost arrivals trail their primary arrival and are generated when an upward traveling wave is recorded a first time on submerged equipment before being reflected at the surface-air contact. The now downward propagating reflected wave is recorded a second time at the receivers 112 and constitutes the ghost. Primary and ghost (receiver side ghost and not the source side ghost) signals are also commonly referred to as up-going and down-going wave fields.

The time delay between an event and its ghost depends upon the depth of the receivers 112 and the wave velocity in water (this can be measured and considered to be approximately 1500 m/s). It can be only a few milliseconds for towed streamer data (depths of less than 15 meters) or up to hundreds of milliseconds for deep Ocean Bottom Cable (OBC) and Ocean Bottom Node (OBN) acquisitions. The degenerative effect that the ghost arrival has on seismic bandwidth and resolution are known. In essence, interference between primary and ghost arrivals causes notches or gaps in the frequency content and these notches cannot be removed without the combined use of advanced acquisition and processing techniques.

One popular technique for separating the up-going and down-going wave fields is called PZ-summation and applies to both OBC/OBN and streamer data. Here, the seismic wave field is recorded using co-located hydrophones (P) and vertical geophones (Z). In other words, the receivers 112 shown in FIG. 1 include two different devices, a hydrophone and a vertically oriented geophone and can, therefore, be considered multi-sensor or multi-component receivers. Hydrophones measure pressure whereas geophones measure particle velocity in the direction they are oriented. Data recorded on both receivers is in phase for up-going waves and of opposite phase for down-going waves, or the ghost. Combining both records involves a calibration to remove differences in frequency response, a unit conversion (which depends on the impedance, defined as the product of water density and wave velocity, of the water) and a time-offset dependent scaling to match amplitudes. After these steps the data can be summed or subtracted to produce estimates of the up-going and down-going wave fields respectively. However, each of the above corrections (spectral matching, unit conversion, and time-offset scaling) has to be estimated and all are prone to errors. As will be appreciated by those skilled in the art, other techniques are known for ghost removal and wave field estimation, generally.

However, it would be useful to be able to estimate the value of different wave field quantities at locations other than the locations where the quantities were sampled. For example, it would be useful to model the up-going wave field at the surface of a body of water when sampling of the wave did not occur at this location, e.g., when sampling occurred thirty meters below the surface. Processing of seismic data in this way would allow for better images to be generated without the requirement to know exactly where every sample point should be collected.

Accordingly, it would be desirable to provide systems and methods that avoid the afore-described problems and drawbacks associated with determining wave field parameters.

### SUMMARY

These and other drawbacks and problems are addressed by embodiments which, for example, provide methods and systems for predicting a seismic data related quantity based on a linear least mean square estimate associated with covariance matrices. The application of a prediction error filter provides, among other things, the ability to derive the prediction for aliased data samples.

According to an embodiment, a method for computing predicted wavefield quantities includes the steps of acquiring seismic data at a first set of locations over a plurality of frequencies, computing first covariance matrices using the seismic data and a first technique over a first set of frequencies, computing second covariance matrices using the seismic data and a second technique, different than the first technique, over a second set of frequencies, and using the first covariance matrices and the second covariance matrices to compute the predicted wavefield quantities, wherein the predicted wavefield quantities are associated with a second set of locations which is different than the first set of locations.

According to another embodiment, a method for regularizing seismic data acquired at a first set of locations includes the steps of regularizing the seismic data relative to a second set of locations, which is different than the first set of locations, by processing the seismic data on a frequency by frequency basis by: computing first covariance values for the seismic data for unaliased frequencies without using a predictive error filter; computing second covariance values for the seismic data for aliased frequencies using the predictive error filter; and predicting wavefield quantities associated with the second set of locations using the first and second covariance values in a linear least mean square estimation process.

According to another embodiment, a system for regularizing seismic data acquired at a first set of locations comprising at least one processor configured to compute first covariance values for the seismic data directly for unaliased frequencies and to compute second covariance values for the seismic data using a predictive error filter (PEF) for aliased frequencies; and wherein the at least one processor is further configured to estimate wavefield quantities for other seismic data at a second set of locations which differ from the first set of locations using the first and second covariance values.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 depicts various aspects of an exemplary marine seismic survey system in which various quantity prediction embodiments can be implemented;

FIGS. 2-3 depict flowcharts of method embodiments;

FIG. 4 depicts various aspects of software components or modules which can be used to implement the embodiments; and

FIG. 5 depicts an exemplary data processing device or system which can be used to implement the embodiments.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to the terminology and structure associated with determining various wave field parameters in exemplary marine seismic configurations. However, the embodiments to be discussed next are not limited to these configurations, but may be extended to other arrangements as discussed later.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to various embodiments described herein, methods and systems for predicting a seismic quantity at a desired location and depth are presented which, for example, model the up-going wavefield at the surface of a body of water when sampling has not occurred at this desired location. Such methods and systems can, for example, be used to reduce the complexity of a seismic survey with regard to the specificity of the locations that must be sampled to perform the acquisition.

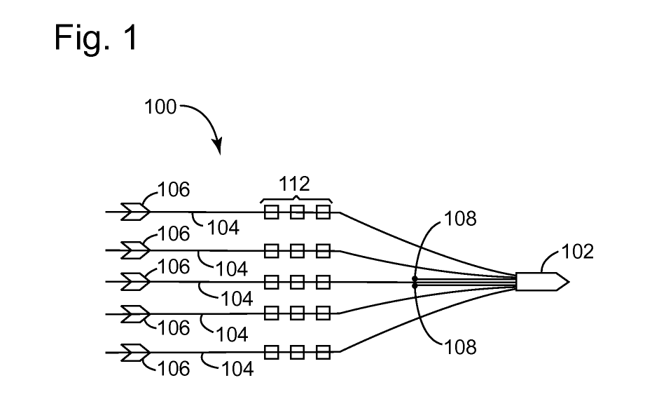

With the seismic survey context of FIG. 1 in mind, various embodiments associated with determining wavefield parameters at locations and/or depths other than those at which the waveforms are sampled will now be discussed. Considering the data associated with an offshore seismic survey, irregularly sampled wavefield data processed by an embodiment, e.g., both collected from distributed sensors of a pressure field and differential pressure, can be used to determine different wavefield quantities at any location and depth. In this context, irregular sampling of data comprises factors such as, but not limited to, irregular sampling depth, irregular spatial location and/or irregular signal-to-noise ratio of the data. It should further be noted in the embodiments below that an example of a determined wavefield quantity is a de-noised up-going (or down-going) wavefield, detected using one or more hydrophones and/or one or more accelerometers.

To accomplish this, according to an embodiment, covariance elements are calculated as parameters used to generate the desired wavefield quantities. For the lower frequencies in the collected data (where aliasing is not an issue), covariance elements are computed directly with the only consideration being removing the evanescent energy. For higher frequencies, where the collected data is aliased, a prediction error filter parameter is also computed and used in the calculation of the covariance elements.

Some notational information will assist the reader in better understanding the embodiments described herein. For example, note that G_{f} is used herein to refer to a fine regular grid on which U0 (the upgoing wavefield) is unaliased and includes, but is not limited to, the streamer's area, m is used herein to refer the available measurements, i.e., h, gx, gy, gz if the sensors are oriented in the X,Y,Z axis directions or αₓ, α_{y}, α_{z} if oriented in any known orientation with respect to the X,Y,Z axes, respectively, i.e., director cosines of the actual orientation, and ωₛ, i.e., ωₕ, ωₓ, ω_{y}, ω_{z}, is used to refer to the sensor impulse responses from sensor manufacturer documentation and w_{d} is the desired wavefield at the desired location and depth.

With this notation in mind, and in general terms, an embodiment comprises using a linear least mean square estimator to predict the desired wavefield quantity using the available, irregularly sampled data, e.g., a wavefield at the surface of the water when the data is irregularly sampled below the water's surface by a submerged streamer. It should be noted that as discussed below, the actual wavefield quantity is represented by the symbol w_{d} and the predicted value of the actual wavefield quantity is represented by the symbol \tilde{w}_{d}. Accordingly, an equation representing a prediction of a desired wavefield according to an embodiment is given by:

\tilde{w}_{d}=C_{w}_{_{d}}_{,m}.C_{m,m}⁻¹.m (1)

where m are the available measurements, \tilde{w}_{d} are the estimated quantities and C_{w}_{_{d}}_{,m} and C_{m,m} are the covariance matrices associated with those measurements or estimated quantities. The computations of the covariance matrices used in equation (1) according to the embodiments are based on certain assumptions. For example, the covariance matrices can be calculated based on the theoretical models of the sensors' response, assuming that the probabilities of propagation of waves in all directions are equal. Another assumption is that the probability of propagation of evanescent waves, i.e. waves slower than the water velocity, is set to zero. Additionally, it is assumed that w_{d} is unaliased based on its estimation over a fine enough grid G_{f} to prevent aliasing.

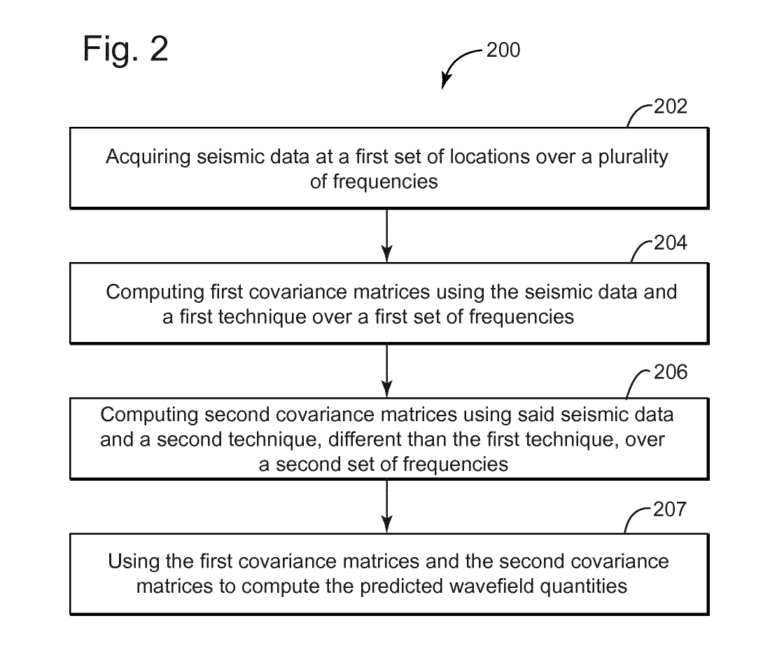

To calculate the predicted quantity w_{d} according to these embodiments, thus involves a determination of the elements of the covariance matrices C_{w}_{_{d}}_{,m} and C_{m,m} but also involves accounting for aliasing effects to make the latter assumption valid. To do this, a general process 200 for predicting wavefield quantities according to the embodiments can be expressed as various steps as shown in FIG. 2. Initially, seismic data can be acquired, e.g., using the marine seismic acquisition system of FIG. 1 or another such system, at step 202. The acquired seismic data will thus be collected over a first set of locations, i.e., based on the locations of the receivers on the streamers in the x, y, z coordinate system and be collected over a range of frequencies.

The data can then be processed in two steps or phases, i.e., a first phase 204 where the acquired seismic data is sufficiently densely sampled that the estimates of the covariance matrices can be calculated by known numerical integration methods, i.e. by a summation over a sufficiently dense sampling of the domain under integration, without considering aliasing effects and a second phase 206 in which the estimates of the covariance matrices need to take aliasing into account. The first phase 204 can be performed for seismic data acquired in a first range of frequencies, while the second phase 206 can be performed for seismic data acquired in second (and different) range of frequencies. Each of these computation or processing steps 204 and 206 will now be described in more detail.

Referring first to step 204 in FIG. 2, if the frequencies for which the covariance matrices are being estimated are below the aliasing condition, i.e., if the data associated with those lower frequencies has a sufficient measurement density according to sampling theory, then the estimate of the desired wavefield quantity will be of acceptable quality and the covariance matrix coefficients can be estimated as follows. Consider two points: point a at location (Xₐ, Y_{b}) and depth Zₐ and point b at location (X_{b}, Y_{b}) and at depth Z_{b} For acquired seismic data associated with an unaliased frequency, the covariance of the seismic data or measurements can be computed, in the X, Y, T domain, by the equation:

C_{a,b}=∫∫∫_{fmin}^{fmax}D(f)Rₐ R̅_̅{̅b̅}̅e^{2iπ(k}^{ₓ}^{Δx+k}^{_{y}}^{Δy+fΔt)}dkₓdk_{y}df (2a)

where:
Δx=Xₐ−X_{b}, Δy=Yₐ−Y_{b}, and Δt=Tₐ−T_{b}, i.e., the separation between the two points a and b in the X-Y plane, and in time relative to the received wave, respectively;
Rₐ is the instrument (sensor and ghost) response at position a and R_{b} is the instrument response at position b;
f is the frequency of interest, and
[symbol] (f) is the domain of the kₓ, k_{y} plane where (f/c)²≦kₓ²+k_{y}² for all points outside
[symbol] (f), i.e., the evanescent portion of the spectrum where the wavefield does not propagate. Alternatively, the covariance of the seismic data or measurements can be computed in the X, Y, F domain on a frequency by frequency basis using the equation:

C_{a,b}(f)=∫∫_{D(f)}Rₐ R̅_̅{̅b̅}̅e^{2iπ(k}^{ₓ}^{Δx+k}^{_{y}}^{Δy)}dkₓdk_{y} (2b)

As a purely illustrative example of the application of equation (2b) in step 204 of FIG. 2, the covariance of a hydrophone at position a and having sensor response Rₐ with a cross-line (xL) geophone at position b and having sensor response R_{b} can be expressed as:

Rₐ=Gₕwₕ=2wₕ(f)i sin(2πzₐκ),

R_{b}=G_{xL}w_{g}=−4w_{g}(f)πk_{y} sin(2πz_{b}κ) and

C_{a,b}(f)=∫∫_{D(f)}Rₐ R̅_̅{̅b̅}̅e^{2iπ(k}^{ₓ}^{Δx+k}^{_{y}}^{Δy)}dkₓdk_{y}.

It should be noted that wₕ(f) (resp. w_{g}(f)) is the known spectral response of the sensors, based on the manufacturer's documentation, and [symbol] ₕ (resp. [symbol] ₓ) is the response with respect to the wavefield (i.e., ghost) of perfect sensors, i.e., a flat frequency response, together with the interaction with the surface;

and K=\sqrt{(f/v_{water})²−kₓ²−k_{y}²}.

Next, in step 206, when estimating covariance matrices for frequencies with aliasing, overcoming the aliasing condition involves an assumption that the desired wavefield quantity is predictable, i.e., that there exists a causal prediction error filter (PEF) such that the difference in the predicted quantity and the actual quantity is insignificant for the intended use of the predicted quantity. Note that although steps 204 and 206 are described here as being sequential, that these steps can be performed in any desired order or in a parallel with one another.

For step 206, consider a field U₀ as either a 3-dimensional object U₀(f, xᵣ, yᵣ) with xᵣ, yᵣ being the position of the receivers or a 5-dimensional object U₀(f, xᵣ, yᵣ, xₛ, yₛ) if the source positions are considered to be variable. Considering a to be a prediction error filter of U₀, then it will be appreciated that such a filter will have the following characteristics: σ(0,0 . . . 0)=1, σ=0 for half space user defined, i.e., ∀(i,j,k,l)≠(0,0,0,0), σ(i,j,k,l)=0 or σ(−i, −j, −k, −l)=0, and |U₀*σ|² is minimal It should be noted that the spectrum of c tends to be zero for the wave-numbers representing the actual data and unconstrained, therefore large, at locations where there is no coherent energy. Accordingly,

$$S = \frac{{ε}^{2}}{{ε}^{2} + {\vert σ \vert}^{2}}$$

is an estimate of the U₀ covariance wherein its value is close to 1 when the data resides in the f, kₓ, k_{y} domain but otherwise close to 0. The computation of the covariances for aliased frequencies can then be performed by calculating:

C_{a,b}(f)=∫∫_{D(f)}S(f, kₓ, k_{y})Rₐ R̅_̅{̅b̅}̅e^{2iπ(k}^{ₓ}^{Δx+k}^{_{y}}^{Δy)}dkₓdk_{y}. (3)

As shown in step 207 of FIG. 2, the first covariance matrices (or equivalently set of covariance matrix elements), i.e., those associated with the unaliased frequencies or data, and the second covariance matrices (or equivalently, set of covariance matrix elements), i.e., those associated with the aliased frequencies or data, are used to compute the predicted wavefield quantities. This can be accomplished by solving equation (1) using the determined covariance values and known methods for solving linear least means square estimate equations.

A few comments on the previous embodiment. It should be noted that the multiple integrals associated with the calculation of the covariances in equations (2) and (3), in general, do not have a closed form and are solved with numerical approximation. Considering another aspect, if the algorithm described in FIG. 2 is performed on a frequency-by-frequency basis, i.e., in the f, x, y domain, then the outer frequency domain integration is not performed and the prediction error filter at frequency fₙ is computed on the result at fₙ₋₁. If performed in the f, x, y domain, then the prediction error filter depends only on x, y only and, if desired, the f, x, y regularization described here can, after all of the frequencies are processed, can be followed by a final update by performing the algorithm in the t, x, y domain. It should further be noted that this algorithm resolves, for example, the deghosting and data regularization of the acquired seismic data, as well as performing de-noising of incoherent noise, in one step. De-noising of the incoherent noise occurs as an inherent part of the process since S(f) has values close to zero for non-data locations. De-noising of coherent noise, e.g., caused by the birds 106, can optionally be modelled and addressed as described below.

Regarding data regularization, as mentioned in the previous paragraph, although embodiments described herein refer to estimating or predicting wavefield quantities at locations other than those where the seismic data was initially acquired, those skilled in the art will appreciate that there are other types of terminology which are generally used to refer to such techniques. For example, these techniques are sometimes referred to as “regularization” techniques. Regularization refers to a process which is performed to transfer seismic data samples from their irregular, recorded to location to a corresponding location on a regular grid of locations. The regularization embodiments described herein can occur either in the common shot gather, e.g., for a predicted quantity at the surface, or in general for the streamer data for a predicted quantity at any depth.

The embodiments described herein can also be extended to perform denoising of coherent noise and, if necessary, the noise covariance of the estimate can also be computed. For example, for some of (or the entire) domain under evaluation, waves' noise can be traveling within a known dispersion law, e.g. waves traveling with a known velocity and frequency range or a sum of such known velocities and frequency ranges. In this case, the noise covariance matrix associated with the measurements is known and can be added to the covariance matrix described above.

In application, all of the different seismic sensors may have a different signal to noise ratio (SNR) but the SNR value can be measured or determined from specifications provided by the manufacturer. Accordingly, the measurements may require scaling to fit a linear least mean square estimate (LLMSE) framework. For example, consider the cross-line sensor measurements, mₓ, the noise model (spectrum) nₓ the autocorrelation factor Nₓ wherein estimating u₀ leads to:

$${m}_{x} = {ω}_{x} \frac{\partial {P}_{z}}{\partial x} + {n}_{x} and {N}_{x}^{- 1} {m}_{x} = {N}_{x}^{- 1} {ω}_{x} {𝒢}_{x} {U}_{0} + {N}_{x}^{- 1} {n}_{x}$$

wherein replacing the physical [symbol] ₓ by Nₓ⁻¹ωₓ [symbol] ₓ and the measurement mₓ by γₓ=Nₓ⁻¹mₓ leads to a set of signals that have the same noise power as that required for the LLMSE to provide an optimal estimate of \tilde{w}_{d}.

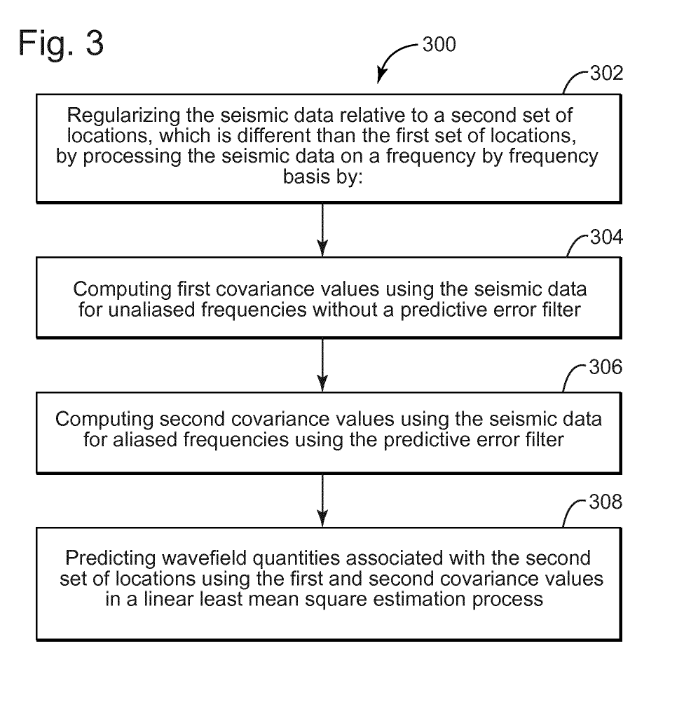

FIG. 2 illustrates one example of a method for computing predicted wavefield quantities (or equivalently for regularizing seismic data) according to an embodiment. However those skilled in the art will appreciate that the embodiments described herein can be expressed differently. For example the flowchart of FIG. 3 describes another embodiment. Therein, method 300 regularizes the seismic data relative to a second set of locations, which is different than the first set of locations, by processing the seismic data on a frequency by frequency (step 302) basis by performing a number of steps. As shown at step 304, first covariance values are computed using the seismic data for unaliased frequencies without using a predictive error filter. However, at step 306, second covariance values are computed using the seismic data for aliased frequencies by using the predictive error filter. At step 308, wavefield quantities associated with the second set of locations are predicted using the first and second covariance values in a linear least mean square estimation process.

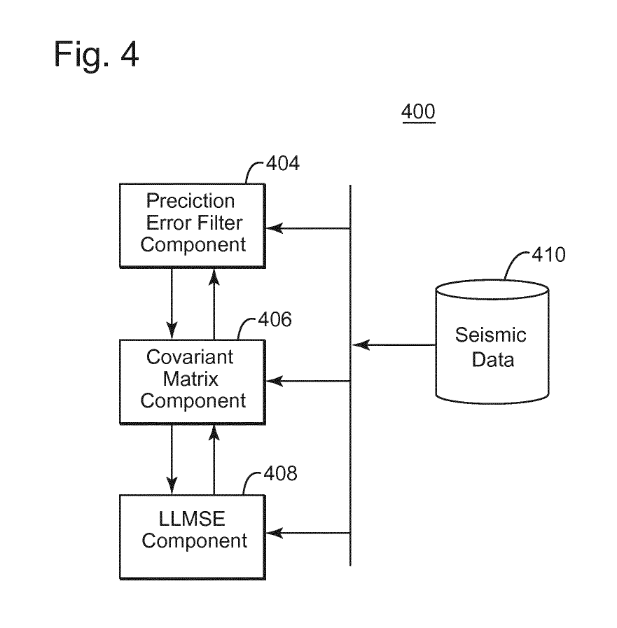

As will be appreciated from the foregoing discussion, methods for predicting a desired seismic quantity at a desired location and a desired depth according to these embodiments can, at least in part, be implemented in software operating on a suitably programmed computing device. An embodiment, with suitable software modules or components, will now be described with respect to FIG. 4. Looking now to FIG. 4, a quantity prediction system 400 comprises a prediction error filter component 404, a covariant matrix component 406, a prediction or LLMSE component 408 and seismic data 410.

Continuing with the system 400, the prediction error filter component 404 provides the capability for computing a prediction error filter based on the seismic data. Next in the system 400, the covariant matrix component 406 provides the capability to compute a covariant matrix based on the seismic data. Continuing with the system 400, the quantity prediction component 408 provides the capability to generate the predicted quantity based on an iterative calculation of the seismic data, e.g., using a linear least means square estimation (LLMSE) technique.

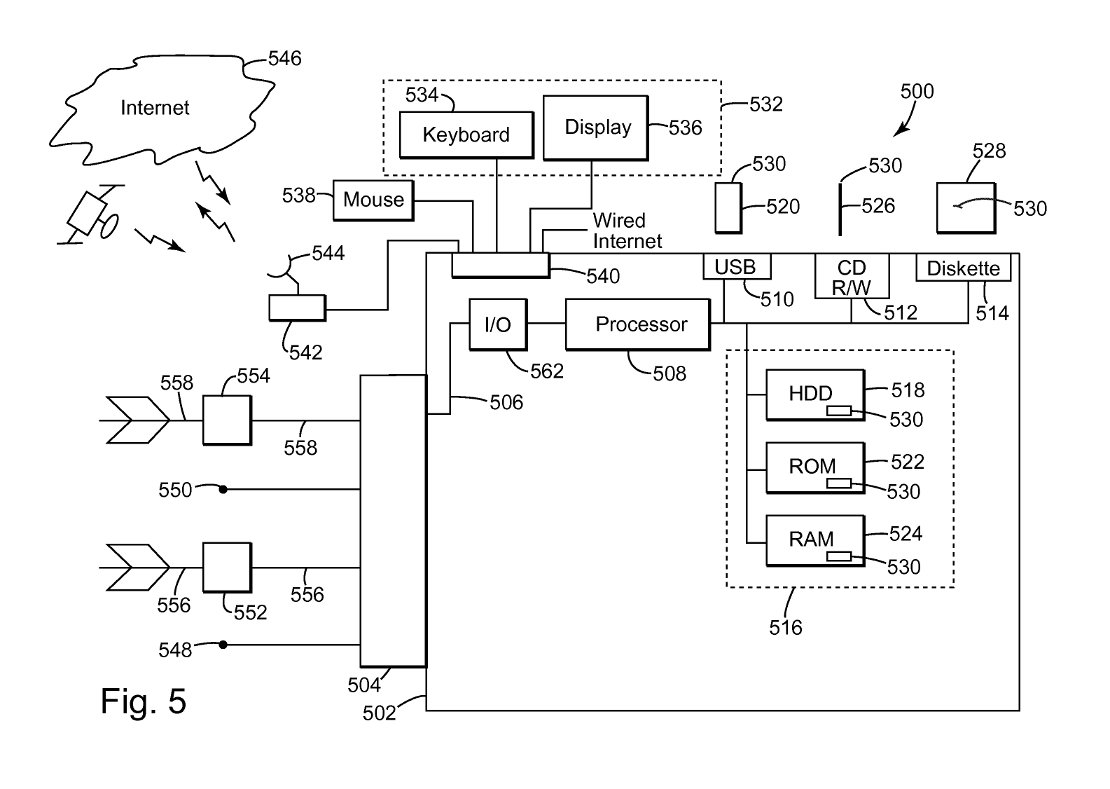

The computing device(s) or other network nodes involved in predicting a desired seismic quantity at a desired location of a desired depth as set forth in the above described embodiments may be any type of computing device capable of processing and communicating seismic data associated with a seismic survey. An example of a representative computing system capable of carrying out operations in accordance with these embodiments is illustrated in FIG. 5. System 500 includes, among other items, server 502, source/receiver interface 604, internal data/communications bus (bus) 506, processor(s) 508 (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 510, compact disk (CD)/digital video disk (DVD) read/write (R/W) drive 512, floppy diskette drive 514 (though less used currently, many servers still include this device), and data storage unit 516.

Data storage unit 516 itself can comprise hard disk drive (HDD) 518 (these can include conventional magnetic storage media, but, as is becoming increasingly more prevalent, can include flash drive-type mass storage devices 520, among other types), ROM device(s) 522 (these can include electrically erasable (EE) programmable ROM (EEPROM) devices, ultra-violet erasable PROM devices (UVPROMs), among other types), and random access memory (RAM) devices 524. Usable with USB port 510 is flash drive device 520, and usable with CD/DVD RAN device 512 are CD/DVD disks 526 (which can be both read and write-able). Usable with diskette drive device 514 are floppy diskettes 528. Each of the memory storage devices, or the memory storage media (518, 520, 522, 524, 526, and 528, among other types), can contain parts or components, or in its entirety, executable software programming code (software) 530 that can implement part or all of the portions of the method described herein. Further, processor 508 itself can contain one or different types of memory storage devices (most probably, but not in a limiting manner, RAM memory storage media 524) that can store all or some of the components of software 530.

In addition to the above described components, system 500 also comprises user console 532, which can include keyboard 534, display 536, and mouse 538. All of these components are known to those of ordinary skill in the art, and this description includes all known and future variants of these types of devices. Display 536 can be any type of known display or presentation screen, such as liquid crystal displays (LCDs), light emitting diode displays (LEDs), plasma displays, cathode ray tubes (CRTs), among others. User console 532 can include one or more user interface mechanisms such as a mouse, keyboard, microphone, touch pad, touch screen, voice-recognition system, among other inter-active inter-communicative devices.

User console 532, and its components if separately provided, interface with server 502 via server input/output (I/O) interface 540, which can be an RS232, Ethernet, USB or other type of communications port, or can include all or some of these, and further includes any other type of communications means, presently known or further developed. System 500 can further include communications satellite/global positioning system (GPS) transceiver device 542, to which is electrically connected at least one antenna 544 (according to an embodiment, there would be at least one GPS receive-only antenna, and at least one separate satellite bi-directional communications antenna). System 500 can access internet 546, either through a hard wired connection, via I/O interface 540 directly, or wirelessly via antenna 544, and transceiver 542.

Server 502 can be coupled to other computing devices, such as those that operate or control the equipment of ship 102 of FIG. 1, via one or more networks. Server 502 may be part of a larger network configuration as in a global area network (GAN) (e.g., internet 546), which ultimately allows connection to various landlines.

According to a further embodiment, system 500, being designed for use in seismic exploration, will interface with one or more sources 548, 550 and one or more receivers 552, 554. As further previously discussed, sources 548, 550 and receivers 552, 554 can communicate with server 502 either through an electrical cable that is part of streamer 556, 558, or via a wireless system that can communicate via antenna 544 and transceiver 542 (collectively described as communications conduit 560).

According to further exemplary embodiments, user console 532 provides a means for personnel to enter commands and configuration into system 500 (e.g., via a keyboard, buttons, switches, touch screen and/or joy stick). Display device 536 can be used to show: streamer 556, 558 position; visual representations of acquired data; source 548, 550 and receiver 552, 554 status information; survey information; and other information important to the seismic data acquisition process. Source and receiver interface unit 504 can receive the seismic data from receiver 552, 554 though communication conduit 560 (discussed above). Source and receiver interface unit 504 can also communicate bi-directionally with sources 548, 550 through the communication conduit 560. Excitation signals, control signals, output signals and status information related to source 548, 550 can be exchanged by communication conduit 560 between system 500 and source 548, 550.

Bus 506 allows a data pathway for items such as: the transfer and storage of data that originate from either the source sensors or receivers; for processor 508 to access stored data contained in data storage unit memory 516; for processor 508 to send information for visual display to display 536; or for the user to send commands to system operating programs/software 530 that might reside in either the processor 508 or the source and receiver interface unit 504.

System 500 can be used to implement the methods described above associated with multi-component dip filtering of ground roll noise according to an exemplary embodiment. Hardware, firmware, software or a combination thereof may be used to perform the various steps and operations described herein. According to an exemplary embodiment, software 530 for carrying out the above discussed steps can be stored and distributed on multi-media storage devices such as devices 518, 520, 522, 524, 526, and/or 528 (described above) or other form of media capable of portably storing information (e.g., universal serial bus (USB) flash drive 520). These storage media may be inserted into, and read by, devices such as the CD-ROM drive 512, the disk drive 514, among other types of software storage devices.

It should be noted in the embodiments described herein that these techniques can be applied in either an “offline”, e.g., at a land-based data processing center or an “online” manner, i.e., in near real time while onboard the seismic vessel. For example, predicting a desired seismic quantity at a desired location of a desired depth can occur as the seismic data is recorded onboard the seismic vessel. In this case, it is possible for the prediction to be generated as a measure of the quality of the sampling run.

The disclosed exemplary embodiments provide a server node, and a method for predicting a desired seismic quantity at a desired location of a desired depth. It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for computing predicted wavefield quantities comprising:
acquiring seismic data at a first set of locations over a plurality of frequencies;
computing first covariance matrices using said seismic data and a first technique over a first set of frequencies;
computing second covariance matrices using said seismic data and a second technique, different than said first technique, over a second set of frequencies; and
using said first covariance matrices and said second covariance matrices to compute the predicted wavefield quantities,
wherein said predicted wavefield quantities are associated with a second set of locations which is different than said first set of locations.

2. The method of claim 1, wherein said seismic data is acquired using sensors disposed on one of: streamers towed by vessels, ocean bottom cables and ocean bottom nodes.

3. The method of claim 2, wherein said first set of frequencies is a range from a lowest sampled frequency to a maximum unaliased frequency.

4. The method of claim 3, wherein said second set of frequencies is a range from a maximum unaliased frequency to a predefined frequency greater than said maximum unaliased frequency.

5. The method of claim 1, wherein said step of acquiring the seismic data further comprises:
acquiring the seismic data using irregularly distributed sensors which are irregularly spaced in depth.

6. The method of claim 5, wherein said irregularly distributed sensors are irregularly distributed in space.

7. The method of claim 1, wherein said first technique further comprises:
calculating:
C_{a,b}(f)=∫∫_{D(f)}Rₐ R̅_̅{̅b̅}̅e^{2iπ(k}^{ₓ}^{Δx+k}^{_{y}}^{Δy)}dkₓdk_{y}
where:
C_{a,b}(f) is the covariance associated with seismic data at points a and b at frequency f;
Δx=Xₐ−X_{b}, Δy=Yₐ−Y_{b}, is the separation between the two points a and b in the X-Y plane,
Rₐ is the instrument (sensor and ghost) response at position a and R_{b} is the instrument response at position b;
f is the frequency of interest, and [symbol]
(f) is the domain of the kₓ, k_{y} plane where (f/c)²≦kₓ²+k_{y}² for all points outside [symbol] (f).

8. The method of claim 1, wherein said second technique further comprises:
calculating:
C_{a,b}(f)=∫ [symbol] _{(f)}S(f, kₓ, k_{y})Rₐ R̅_̅{̅b̅}̅e^{2lπ(k}^{ₓ}^{Δx+k}^{_{y}}^{Δy)}dkₓdk_{y}
where:
C_{a,b}(f) is the covariance associated with seismic data at points a and b at frequency f;
S(f, kₓ, k_{y}) is an estimate of the covariance of a wavefield based on a predictor error filter;
Δx=Xₐ−X_{b}, Δy=Yₐ−Y_{b}, and Δt=Tₐ−T_{b}, i.e., the separation between the two points a and b in the X-Y plane, and in time relative to the received wave, respectively;
Rₐ is the instrument (sensor) response at position a and R_{b} is the instrument response at position b;
f is the frequency of interest, and [symbol]
(f) is the domain of the kₓ, k_{y} plane where (f/c)²≦kₓ²+k_{y}² for all points outside [symbol] (f).

9. The method of claim 2, wherein the step of using said first covariance matrices and the second covariance matrices to compute the predicted wavefield quantities is based on a linear least mean square estimation.

10. A method for regularizing seismic data acquired at a first set of locations comprising:
regularizing the seismic data relative to a second set of locations, which is different than the first set of locations, by processing the seismic data on a frequency by frequency basis by:
computing first covariance values for the seismic data for unaliased frequencies without using a predictive error filter;
computing second covariance values for the seismic data for aliased frequencies using the predictive error filter; and
predicting wavefield quantities associated with the second set of locations using the first and second covariance values in a linear least mean square estimation process.

11. The method of claim 10, wherein said first covariance values are computed by
calculating:
C_{a,b}(f)=∫∫_{D(f)}Rₐ R̅_̅{̅b̅}̅e^{2iπ(k}^{ₓ}^{Δx+k}^{_{y}}^{Δy)}dkₓdk_{y},
where:
C_{a,b}(f) is the covariance associated with seismic data at points a and b at frequency f;
Δx=Xₐ−X_{b}, Δy=Yₐ−Y_{b}, is the separation between the two points a and b in the X-Y plane,
Rₐ is the instrument (sensor and ghost) response at position a and R_{b} is the instrument response at position b;
f is the frequency of interest, and [symbol]
(f) is the domain of the kₓ, k_{y} plane where (f/c)²≦kₓ²+k_{y}² for all points outside [symbol] (f).

12. The method of claim 11, wherein said second covariance values are computed by calculating:
C_{a,b}(f)=∫ [symbol] _{(f)}S(f, kₓ, k_{y})Rₐ R̅_̅{̅b̅}̅e^{2lπ(k}^{ₓ}^{Δx+k}^{_{y}}^{Δy)}dkₓdk_{y}
where:
C_{a,b}(f) is the covariance associated with seismic data at points a and b at frequency f;
S(f, kₓ, k_{y}) is an estimate of the covariance of a wavefield based on a predictor error filter;
Δx=Xₐ−X_{b}, Δy=Yₐ−Y_{b}, is the separation between the two points a and b in the X-Y plane;
Rₐ is the instrument (sensor and ghost) response at position a and R_{b} is the instrument response at position b;
f is the frequency of interest, and [symbol]
(f) is the domain of the kₓ, k_{y} plane where (f/c)²≦kₓ²+k_{y}² for all points outside [symbol] (f).

13. A system for regularizing seismic data acquired at a first set of locations comprising:
at least one processor configured to compute first covariance values for the seismic data directly for unaliased frequencies and to compute second covariance values for the seismic data using a predictive error filter (PEF) for aliased frequencies and
wherein the at least one processor is further configured to estimate wavefield quantities for other seismic data at a second set of locations which differ from the first set of locations using the first and second covariance values.

14. The system of claim 13, wherein said at least one processor is further configured to calculate the first covariance values by calculating:
C_{a,b}(f)=∫∫_{D(f)}Rₐ R̅_̅{̅b̅}̅e^{2iπ(k}^{ₓ}^{Δx+k}^{_{y}}^{Δy)}dkₓdk_{y},
where:
C_{a,b}(f) is the covariance associated with seismic data at points a and b at frequency f;
Δx=Xₐ−X_{b}, Δy=Yₐ−Y_{b}, is the separation between the two points a and b in the X-Y plane;
Rₐ is the instrument (sensor and ghosts) response at position a and R_{b} is the instrument response at position b;
f is the frequency of interest, and [symbol]
(f) is the domain of the kₓ, k_{y} plane where (f/c)²≦kₓ²+k_{y}² for all points outside [symbol] (f).

15. The system of claim 13, wherein said at least one processor is further configured to calculate the second covariance values by calculating:
C_{a,b}(f)=∫ [symbol] _{(f)}S(f, kₓ, k_{y})Rₐ R̅_̅{̅b̅}̅e^{2lπ(k}^{ₓ}^{Δx+k}^{_{y}}^{Δy)}dkₓdk_{y}
where:
C_{a,b}(f) is the covariance associated with seismic data at points a and b at frequency f;
S(f, kₓ, k_{y}) is an estimate of the covariance of a wavefield based on a predictor error filter;
Δx=Xₐ−X_{b}, Δy=Yₐ−Y_{b}, is the separation between the two points a and b in the X-Y plane;
Rₐ is the instrument (sensor) response at position a and R_{b} is the instrument response at position b;
f is the frequency of interest, and [symbol]
(f) is the domain of the kₓ, k_{y} plane where (f/c)²≦kₓ²+k_{y}² for all points outside [symbol] (f).

16. The system of claim 13, wherein said seismic data is acquired using sensors disposed on one of: streamers towed by vessels, ocean bottom cables and ocean bottom nodes.
